(19) United States
(12) Patent Application Publication
(10) Pub. No.: US 2015/0349393 A1
(43) Pub. Date: Dec. 3, 2015

(54) MANAGEMENT OF HIGH-TEMPERATURE BATTERIES

(71) Applicant: COMMISSARIAT A L'ENERGIE ATOMIQUE ET AUX ENERGIES ALTERNATIVES, Paris (FR)

(72) Inventor: Nicolas MARTIN, PEYRIEU (FR)

(21) Appl. No.: 14/653,538

(22) PCT Filed: Dec. 20, 2013
(86) PCT No.: PCT/FR2013/053228

§ 371 Date: Jun. 18, 2015

(30) Foreign Application Priority Data
Dec. 20, 2012 (FR) 1262456

(51) Int. Cl. H01M 10/635; H01M 10/627; H01M 10/615; H02J 3/38; H02J 3/32

(52) U.S. Cl. CPC H01M 10/635; H02J 3/383; H02J 3/32; H01M 10/615; H01M 10/627

(57) ABSTRACT

The invention relates to a method for the management of at least one high-temperature electrochemical battery (30) comprising the following steps: evaluating (32) the production capacities of an electrical network and/or evaluating (31) the consumption needs of the users of this network, for a future period; deciding (33) whether or not to use the battery during the future period, according to the result of the evaluation step; and bringing (36) the battery to an operating temperature or restoring (38) the battery to an idle state at an ambient temperature according to the decision made.

### CROSS-REFERENCE TO RELATED APPLICATIONS

The present application is a National Stage of PCT International Application Serial Number PCT/FR2013/053228, filed Dec. 20, 2013, which claims priority under 35 U.S.C. §119 of French Patent Application Serial Number 12/62456, filed Dec. 20, 2012, the disclosures of which are incorporated by reference herein.

### BACKGROUND

The present invention generally relates to power management in an electric power distribution system and, more particularly, to the management of high-temperature electro-chemical electricity storage batteries.

### DISCUSSION OF RELATED ART

So-called high-temperature batteries are electro-chemical batteries used in power distribution systems. This type of battery is also known as “Sodium Beta” batteries, which particularly comprise sodium/nickel chloride batteries (Zebra batteries) as well as sodium/sulfur batteries. All these batteries are high-capacity batteries (several tens of kilowatts hours) and are generally implanted in the electric power distribution system, that is, between high or medium voltage-to-low voltage transformer substations and subscribers.

Power storage means such as batteries are generally desirable in electric power systems to absorb power consumption or generation peaks. Indeed, in the absence of such storage elements, it is necessary to size the electric power generation and distribution system so that it is capable of meeting the demand and the production, including in periods of high power consumption/generation having peaks which generally only amount to a few hours during a few days per year.

High-temperature batteries form convenient storage means since they can easily be placed close to power consumption sites, which is not true for other power distribution regulation means of hydraulic storage type. However, a difficulty is that such batteries have to be taken to a temperature of several hundred degrees (typically in the order of 300° C.) to operate (in charge and in discharge mode). As a result from the need to take them to a high temperature for their operation, the batteries are practically permanently maintained at the operating temperature.

This increases the cost of power, not only due to the need to permanently heat the batteries, but also because this limits the lifetime of such batteries. Indeed, batteries of high-temperature type have a limited lifetime, in the order of some ten years of high-temperature operation.

Document “Analysis and Operational Records of NAS Battery” of K. Iba et al, R. Ideta, and K. Suzuki—Universities Power Engineering Conference, 2003—UPEC '06. Proceedings of the 41st International, IEEE, P1, Sep. 1, 2006, pages 491-495, describes a method of regulating the temperature of NAS-type batteries.

Document GB-A-2081000 also describes a method of regulating the temperature of NAS batteries.

Document “Overview of the Sodium-Sulfur Battery for the IEEE substationary Battery Committee” of A. Bito—Power Engineering Society General Meeting, 2005—IEEE San Francisco, USA—Jun. 12-16, 2005—pages 2346-2349, gives an overview of NAS-type batteries.

Document “Battery Storage System sizing in distribution feeders with distributed photovoltaic systems” of C. Venu et al. Powertech 2008 IEEE Bucharest, IEEE, Piscataway, N.J., USA—Jun. 28, 2009—pages 1-5, describes a system combining batteries and a photovoltaic power generation.

All the above documents insist on the importance, in NAS batteries, of regulating the temperature to avoid temperature variations adversely affecting the lifetime of such batteries.

### SUMMARY

Thus, an object of an embodiment of the present description aims at overcoming all or part of the disadvantages of the use of high-temperature batteries.

Another object of an embodiment is to increase the lifetime of high-temperature batteries and, more particularly, batteries capable of withstanding temperature variations.

Another object of an embodiment is to optimize the use of high-temperature batteries in an electric power system.

Another object of an embodiment is to provide a solution more particularly adapted to sodium-beta-type batteries.

To achieve all or part of these and other objects, a method of managing at least one high-temperature electrochemical battery is provided, wherein the battery is taken to a nominal operating temperature after a detection of a need for use.

According to an embodiment, a method of managing at least one high-temperature electrochemical battery is provided, comprising the steps of:

estimating the power generation capacities of an electric power system and/or estimating the power consumption needs of the users of this system, for a future period;

deciding whether to use or not the battery during the future period, according to the result of the estimation step;

taking the battery to an operating temperature or taking back the battery at rest to the ambient temperature according to the decision which has been made; and

repeating the above steps.

According to an embodiment, the difference between the ambient temperature and the operating temperature is at least 100° C.

According to an embodiment, the aging of the battery at ambient temperature is at least twice slower than its aging at the operating temperature.

According to an embodiment, the passing from the ambient temperature to the operating temperature and conversely takes several hours.

According to an embodiment, the estimation steps are carried out in anticipated manner by taking into account the time necessary to take the battery or the batteries to their operating temperature.

According to an embodiment, the estimation steps are carried out daily for the next day.

A method of power management in an electric power system is also provided, wherein high-temperature electrochemical batteries are used to store the power generated by decentralized solar power plants.

An electric power system capable of implementing the power management method is also provided.

### BRIEF DESCRIPTION OF THE DRAWINGS

The foregoing and other features and advantages will be discussed in detail in the following non-limiting description of specific embodiments in connection with the accompanying drawings, among which:

FIG. 1 is a simplified representation of an electric power system of the type to which the embodiments which will be described apply;

FIGS. 2A, 2B, and 2C are timing diagrams very schematically illustrating an example of operation of the power management method; and

FIG. 3 is a simplified block diagram of an embodiment of the power management method.

### DETAILED DESCRIPTION

The same elements have been designated with the same reference numerals in the different drawings, which have been drawn out of scale. For simplification, only those steps and elements which are useful to the understanding of the described embodiments have been shown and will be detailed. In particular, the power generation installations have not been detailed, the described embodiments being compatible with usual installations fitting power systems. Further, the forming of a high-temperature electrochemical battery has not been detailed either, the described embodiments being here again compatible with usual batteries.

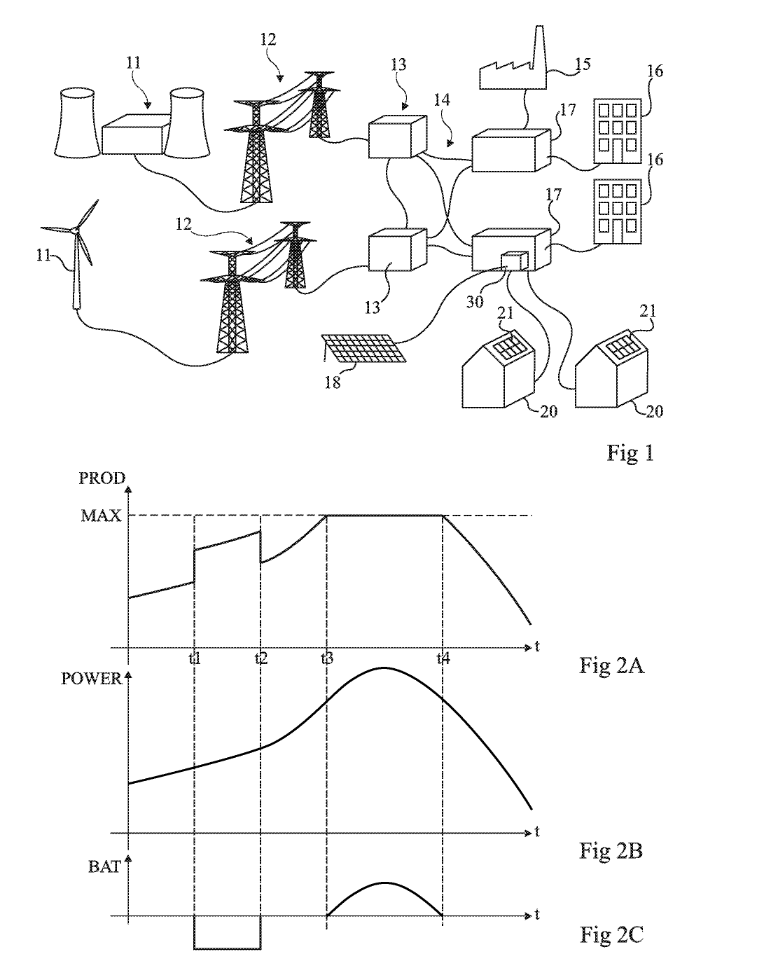

FIG. 1 is a very simplified representation of an example of an electric power system of the type to which the embodiments which will be described apply.

Such a system can be generally found in any region or country. Typically, an electric power system comprises power generation units 11, for example, of nuclear, thermal, hydraulic, wind farm type etc., a transport system, for example, an overhead system (towers and cables) 12 or a buried system between the power generation units and very high voltage-to-medium voltage or low voltage transformer substations 13. Such transformers or source substations have a distribution system 14 in charge of conveying the medium or low voltage towards users, for example, industries 15, apartment buildings 16 or individual houses 20, possibly via secondary transformer substations 17, located downstream thereof. Generation units (for example, of solar power plant type 18) may also directly provide power to a secondary transformer substation 17. There further exist more and more mini- or micro power generation plants, for example, solar panels 21 installed on the roof of houses or buildings, which are capable of injecting power back into the system.

To ease the regulation and the management of the power distributed according to the demand, the electric power system more and more often integrates decentralized storage systems, for example, high-temperature electrochemical batteries 30. In the example of FIG. 1, although a single battery 30 has been shown as associated with a transformer 17, such decentralized storage elements may be distributed in multiple locations of the system.

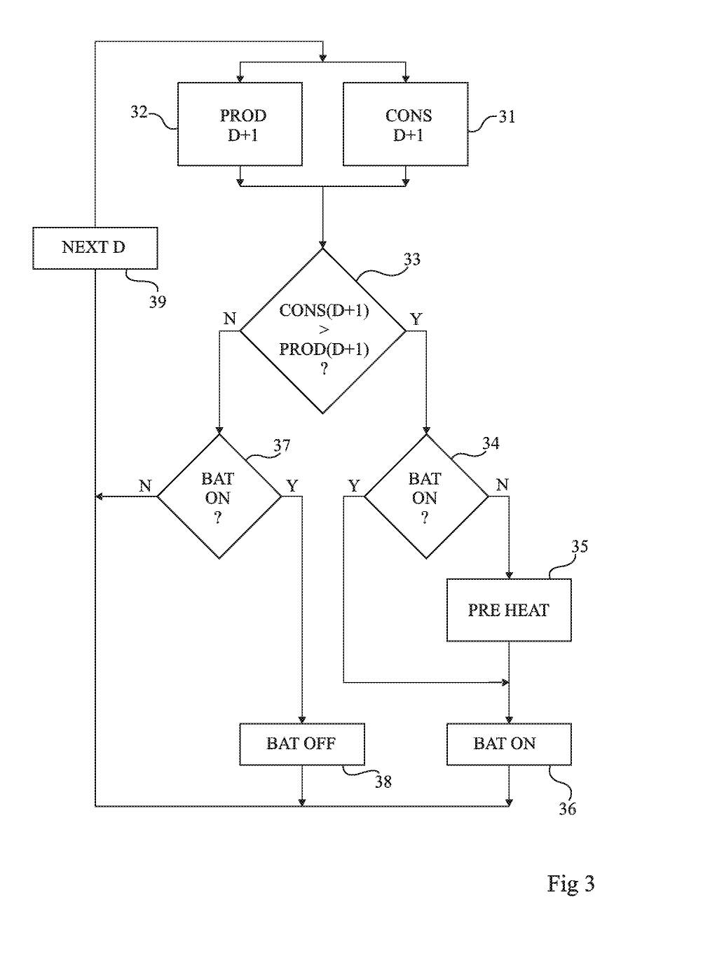

FIGS. 2A, 2B, and 2C are timing diagrams illustrating an example of power management in an electric power system by means of a high-temperature electrochemical battery-type storage element. FIG. 2A illustrates an example of the time variation of the power generation (PROD) provided by the various power plants, for example, during a day. FIG. 2B illustrates the power demand of the system (POWER), that is, the power consumption needs. FIG. 2C illustrates the variation of the power (BAT) in the battery.

It is assumed that at the beginning of the considered time period, the power demanded by the system does not exceed the maximum power generation capacity MAX of the power plants. Advantage is then taken thereof to recharge the battery (between times t1 and t2). The power stored in the battery is then used for another period, for example, in the day (between times t3 and t4) during which the power needs of the distribution system exceed the maximum power generation capable of being provided by the power plants. Such a power management avoids having to oversize the system as a function of occasional consumption peaks. FIGS. 2A to 2C have been described in relation with the use of a storage element but, in practice, when using decentralized storage elements, such an operation may be repeated at the level of the various storage elements.

The lifetime of high-temperature electrochemical batteries is however limited. This lifetime depends on the number of (charge-discharge) cycles of battery use (cycling aging), as well as on time (calendar aging).

A great part of currently used high-temperature batteries are NAS-type (sodium sulfide) batteries. As particularly indicated by the documents mentioned at the beginning of the present disclosure, the temperature of such batteries is desired to be regulated so that they can be preserved. Such a regulation aims at limiting temperature variations around their nominal operating temperature (several hundred degrees). Indeed, NAS-type batteries are not capable of withstanding a cycling in terms of temperature rise-fall between the nominal operating temperature and the ambient temperature (typically of a few tens of degrees, in the order of 20-25 degrees). This is why it is usually desired to maintain them at their nominal operating temperature, be they used or not. Such a cycling in terms of temperature rise-fall is different from the charge-discharge cycling.

The inventors have observed that other types of batteries withstand a cycling in terms of temperature rise-fall between the ambient temperature (typically 25° C.) and a nominal operating temperature (in the order of 300° C.). This is for example true for sodium-beta-type batteries.

Further, for sodium-beta-type batteries, the number of charge-discharge cycles that the battery is capable of with-standing is considered to be in the order of 3,000 and the calendar aging at the nominal operating temperature (in the order of 300° C.) is considered to be approximately 10 years.

The inventor has further observed that the batteries might be used to absorb power consumption peaks in the order of one cycle per day only, and this, for a few months per year. Estimating the number of months to four, this means that the battery lifetime will be limited by the calendar aging while it could withstand a larger number of cycles. High-temperature batteries of this type are thus generally under-utilized.

However, the calendar aging of a high-temperature electrochemical battery is not the same according to whether the battery is at rest at its normal operating temperature or at rest at the ambient temperature. It ages less at ambient temperature, where its lifetime is of several tens of years.

The inventor has observed that by using the batteries in periods where they are really useful from the point of view of the electric system, that is, in periods with high power consumption peaks, it is possible to increase the lifetime of batteries by taking them back to the ambient temperature outside of operating periods. Advantage is thus taken from the fact that certain batteries withstand a temperature rise-fall cycling to control a battery heating and/or cooling system. A difficulty however is that several hours, or even one day, are necessary to take a high-temperature electrochemical battery to its operating temperature. The system reactivity accordingly raises an issue.

It is provided to exploit power consumption prediction and power generation prediction tools to determine periods during which electrochemical batteries are placed at their operating temperature. The possibility of providing, based on the weather forecast, periods of power generation by the decentralized mini power plants (in particular, power generation by mini solar power plants) of the system, is then used. The power consumption estimation based on the history of the power consumption as well as on various parameters such as the weather, the news (for example, a major broadcast sports event) are also used to optimize the battery management.

Such a solution is particularly adapted to the existence of decentralized power generation sites having power generation capacities of the same order of magnitude as the storage capacity of electrochemical batteries (a few tens of kilowatts). It is accordingly now possible to disseminate the storage elements over an entire territory to optimize and adjust at best the power management by minimizing the transport, which is a source of losses.

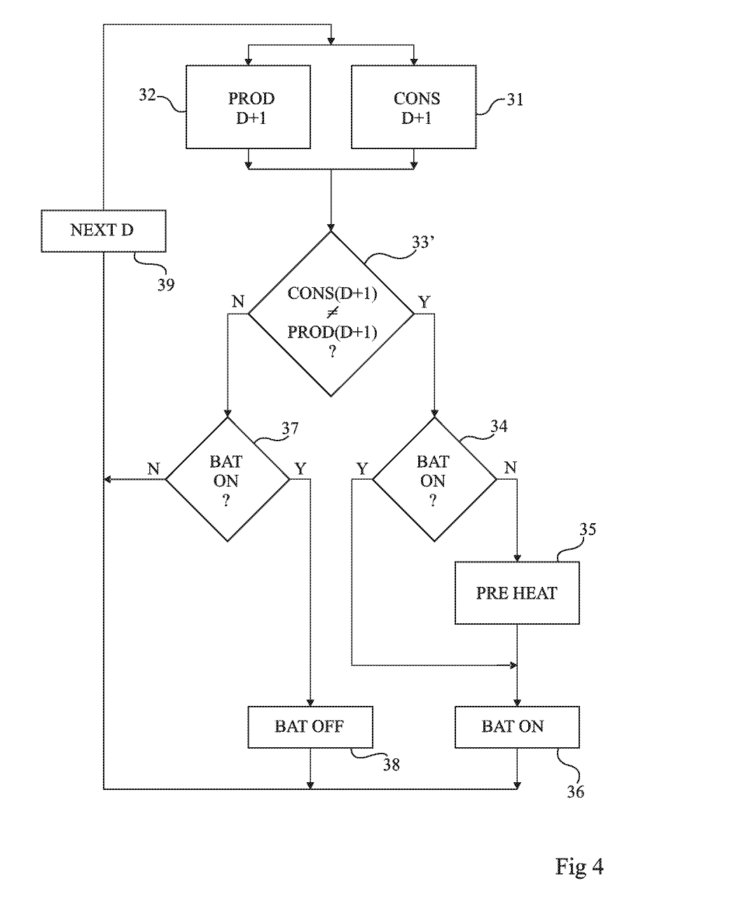

FIG. 3 is a simplified flowchart of an embodiment of the battery management method. Even though this drawing will be described in relation with an example of use of a single battery, it should be noted that it easily transposes whatever the number of batteries.

It is considered, as an example, that the time necessary to place a battery in its operating conditions (time required to take the battery to an operating temperature of several hundred degrees) is in the order of one day. The described method may adapt to other durations, but the example of one day corresponds to a realistic example which, moreover, perfectly adapts to the power generation periodicity of solar power plants (generation during the day, when the power demand is lower) and to the periodicity of power consumption peaks (maximum power consumption at the beginning and at the end of a day when solar power generation is low or nonexistent).

In the example of FIG. 3, the power consumption needs (block 31, CONS D+1) as well as the power generation capacities (block 32, PROD D+1), in particular the decentralized power generation capacities, are estimated daily. Tools for estimating the power consumption based on the weather forecast, on the period of the year, on the expected news events, etc., are known and usable for this purpose. Similarly, tools for estimating the power generation and in particular the decentralized generation by mini solar power plants distributed across a territory according to their location and, particularly, to the weather forecast, are also available and capable of being used to estimate the power generation of the next day.

It is then estimated whether the instantaneous power consumption needs, in a future period (for example, the next day), will be greater than the generation capacities (block 33, CONS(D+1)>PROD(D+1)?) of this future period. If so (output Y of block 33), this means that the battery should be started, that is, able to be charged during time ranges of the next day when the power generation will exceed the power consumption, to then be discharged during the next power consumption peak. Advantage is here taken from the fact that there always exists, in a daily period, time intervals where the power generation is greater than the power consumption (see FIGS. 2).

It is started (block 34, BAT ON?) by detecting the battery state (at rest at ambient temperature (BAT OFF) or at high temperature (BAT ON)), that is, if it already is at its operating temperature, for example, because it is being used for the current day.

If it is not so (output N of block 34), the battery is preheated to be taken it to the operating temperature (block 35, PRE HEAT). If the battery already was at the operating temperature (output Y of block 34), step 35 is of course skipped. The interval between the operating temperature and the ambient temperature is, in practice, at least some hundred degrees. It is not desired to regulate the temperature of the battery around a value but rather to “switch” its temperature between two values distant from each other, to take advantage of the different aging conditions.

The battery is then serviceable (state BAT ON, block 36).

In the case where the power consumption conditions expected for the next day do not risk exceeding the instantaneous power generation capacities (output N of block 33), the battery can then be placed at rest at ambient temperature (in the order of 25° C.) to limit its aging.

To achieve this, it is verified that the battery is in an operating state (block 37, BAT ON?). If it is (output Y of block 37), the battery is taken back to the ambient temperature (block 38, BAT OFF), that is, the heating elements of the battery are stopped and it returns back down, by itself, to the ambient temperature (or a cooling system is activated if the process is desired to be accelerated). If the battery already is at ambient temperature (output N of block 37), nothing is changed.

Steps 31 to 38 are repeated daily (block 39, NEXT D) or with a periodicity corresponding to the periodicity selected to place the battery in operation. This periodicity may depend, in particular, on the time required to take an electrochemical battery to its operating temperature. The selection of the time at which steps 31 to 38 should be implemented is of no importance, but the same time will preferably always be selected from one day to the other.

FIG. 4 is a simplified timing diagram illustrating an alternative embodiment of the method. As compared with FIG. 3, the difference is that test 33 is replaced with a test 33′ (CONS(D+1) PROD(D+1)?) during which it is estimated whether the power consumption expected for the future period will be different from the power generation expected for this future period. If it is so, the battery is placed in its operating condition (blocks 34, 35, and 36), be it to charge it (power consumption smaller than the power generation) or to discharge it (power consumption greater than the power generation). If it is not, the battery is taken back down to the ambient temperature (blocks 37 and 38).

According to other simplified variations, not shown, only the power generation expected for the future period or only the expected power consumption are estimated. The battery is then placed in its operating condition if the expected power generation (or consumption) is greater than a threshold. This prepares the battery either to be charged or to be discharged.

The above-described method may be implemented by means of computer tools currently present in the control centers of the electric power system. The control of the batteries, and particularly their preheating, is easily performed from a distance, the equipment of an electric power system being now almost totally remote-controllable.

It should be noted that, during periods when the battery is at its operating temperature, a temperature regulation mechanism of the type described in the above-mentioned documents may be implemented.

Implementing such a power management method considerably increases the lifetime of electrochemical batteries while optimizing the system management and the use of the decentralized storage elements.

An advantage induced by the use of high-temperature batteries is to help maintaining the voltage map (mean voltage level) of the power distribution system, on which power generation units of solar power plant type may have a significant impact. Indeed, during periods of high solar power generation, the voltage level of the system is difficult to regulate, in particular if the power consumption is not significant, the voltage then tends to increase. The fact of charging the batteries during these periods generates a power consumption which contributes to improving the voltage map. Similarly, the battery discharge at the time when the power consumption becomes significant and when the photovoltaic power generation drops and would thus risk generating a voltage drop supplies power enabling to avoid or to lessen this phenomenon.

Various embodiments have been described, various alterations, modifications, and improvements will occur to those skilled in the art. Further, the practical implementation of the described embodiments is within the abilities of those skilled in the art based on the functional indications given hereabove and by using usual power generation and consumption estimation tools and adapted computing tools. Further, the selection of the batteries to which the described embodiments are capable of applying depends on their aging conditions at ambient temperature and at the operating temperature. Preferably, battery types having an aging ratio between the two temperatures of at least 2 will be selected. Such is the case for sodium-beta-type batteries. Further, although a solution applying to batteries having an operating temperature higher than the ambient temperature has been described, these embodiments may be transposed to batteries having a nominal operating temperature lower than the ambient temperature by applying a cooling instead of a heating.

1. A method of managing at least one high-temperature electrochemical battery comprising the steps of:
estimating the production capacities of an electric power system and/or estimating the power consumption needs of the users of this system, for a future period;
deciding whether to use or not the battery during the future period, according to the result of the estimation step;
taking the battery to an operating temperature or taking back the battery at rest to the ambient temperature according to the decision which has been made; and
repeating the above steps.

2. The method of claim 1, wherein the difference between the ambient temperature and the operating temperature is at least 100° C.

3. The method of claim 1, wherein the aging of the battery at ambient temperature is at least twice slower than its aging at the operating temperature.

4. The method of claim 1, wherein the passing from the ambient temperature to the operating temperature and conversely takes several hours.

5. The method of claim 1, wherein the estimation steps are carried out in anticipated manner by taking into account the time necessary to take the battery or the batteries to their operating temperature.

6. The method of claim 1, wherein the estimation steps are carried out daily for the next day.

7. A method of power management in an electric power system, wherein high-temperature electrochemical batteries are used to store the power generated by decentralized solar power plants, by implementing the method of estimating the production capacities of an electric power system and/or estimating the power consumption needs of the users of this system, for a future period; deciding whether to use or not the battery during the future period, according to the result of the estimation step; taking the battery to an operating temperature or taking back the battery at rest to the ambient temperature according to the decision which has been made; and repeating the above steps.

8. An electric power system capable of implementing the method of power management in an electric power system, wherein high-temperature electrochemical batteries are used to store the power generated by decentralized solar power plants, by implementing the method of: estimating the production capacities of an electric power system and/or estimating the power consumption needs of the users of this system, for a future period; deciding whether to use or not the battery during the future period, according to the result of the estimation step; taking the battery to an operating temperature or taking back the battery at rest to the ambient temperature according to the decision which has been made; and repeating the above steps.

9. The method of claim 2, wherein the estimation steps are carried out in anticipated manner by taking into account the time necessary to take the battery or the batteries to their operating temperature.

10. The method of claim 3, wherein the estimation steps are carried out in anticipated manner by taking into account the time necessary to take the battery or the batteries to their operating temperature.

11. The method of claim 4, wherein the estimation steps are carried out in anticipated manner by taking into account the time necessary to take the battery or the batteries to their operating temperature.

12. The method of claim 2, wherein the estimation steps are carried out daily for the next day.

13. The method of claim 3, wherein the estimation steps are carried out daily for the next day.

14. The method of claim 4, wherein the estimation steps are carried out daily for the next day.

15. The method of claim 9, wherein the estimation steps are carried out daily for the next day.

16. The method of claim 10, wherein the estimation steps are carried out daily for the next day.

17. The method of claim 11, wherein the estimation steps are carried out daily for the next day.

18. The method of claim 2, wherein the estimation steps are carried out daily for the next day.

19. The method of claim 3, wherein the estimation steps are carried out daily for the next day.

20. The method of claim 4, wherein the estimation steps are carried out daily for the next day.
